(19) United States
(12) Patent Application Publication
(10) Pub. No.: US 2006/0282770 A1
(43) Pub. Date: Dec. 14, 2006

(54) Methods and systems for providing editable messaging forms

(75) Inventor: James C. Lee, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/148,141

(22) Filed: Jun. 8, 2005

(51) Int. Cl. G06F 17/00

(52) U.S. Cl. 715/530; 715/505

(57) ABSTRACT

Systems and methods are disclosed for providing editable messaging forms. The disclosed systems and methods may include receiving a template having at least one template field. Furthermore, the disclosed systems and methods may include mapping the at least one template field to at least one handler corresponding to the at least one template field. In addition, the disclosed systems and methods may include executing the at least one handler to produce content associated with the at least one template field.

### BACKGROUND OF THE INVENTION

I. Field of the Invention

The present invention generally relates to methods and systems for providing editable messaging forms. More particularly, the present invention relates to providing editable messaging forms using, for example, templates to allow editable look and feel of the messaging forms.

II. Background Information

Conventional e-mail reader software modules use a static frame to display the various fields in an e-mail form. For example, when an e-mail message is opened, the code corresponding to the reader software module will produce a very static output layout. In other words, the code will render the e-mail in one form regardless of what the user desires. For example, the code will receive the data corresponding to the e-mail and render it in one format for all users regardless of the user or the e-mail's content. Thus, the conventional strategy is to rely on a static frame to display the various fields in an e-mail form. This often causes problems because the conventional strategy results in a boring and mundane user experience.

In view of the foregoing, there is a need for methods and systems for providing editable messaging forms more optimally. Furthermore, there is a need for providing editable messaging forms using, for example, templates to allow editable look and feel of the messaging forms.

### SUMMARY OF THE INVENTION

Consistent with embodiments of the present invention, systems and methods are disclosed for providing editable messaging forms.

In accordance with one embodiment, a method for providing editable messaging forms comprises receiving a template having at least one template field, mapping the at least one template field to at least one handler corresponding to the at least one template field, and executing the at least one handler to produce content associated with the at least one template field.

According to another embodiment, a system for providing editable messaging forms comprises a memory storage for maintaining a database and a processing unit coupled to the memory storage, wherein the processing unit is operative to receive a template having at least one template field, map the at least one template field to at least one handler corresponding to the at least one template field, and execute the at least one handler to produce content associated with the at least one template field.

In accordance with yet another embodiment, a computer-readable medium which stores a set of instructions which when executed performs a method for providing editable messaging forms, the method executed by the set of instructions comprising receiving a template having at least one template field, mapping the at least one template field to at least one handler corresponding to the at least one template field, and executing the at least one handler to produce content associated with the at least one template field.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary computing device consistent with an embodiment of the present invention;

FIG. 2 is a flow chart of an exemplary method for providing editable messaging forms corresponding to user input consistent with an embodiment of the present invention;

FIG. 3 is a flow chart of an exemplary subroutine used in the exemplary method of FIG. 2 for executing at least one handler consistent with an embodiment of the present invention;

FIG. 4 is a screen shots illustrating a first message consistent with an embodiment of the present invention; and

FIG. 5 is a screen shots illustrating a second message consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding stages to the disclosed methods. Accordingly, the following detailed description does not limit the invention. Instead, the proper scope of the invention is defined by the appended claims.

Systems and methods consistent with embodiments of the present invention provide editable messaging forms that may improve e-mail message appearance. Conventional e-mail messages rely on a static frame to display the various fields in an e-mail form. Unfortunately, this results in a boring and mundane user experience. Embodiments of the present invention, for example, may provide a system for using templates (e.g. HTML templates) and handler objects to provide an editable look and feel of messaging forms. By using templates and handler objects, embodiments of the present invention may alter the read form appearance, allow creation of form parts of other forms, and reload different forms in a same window. A customized image may surround the image and a background sound can play as the form is displayed. The look and feel can be customized by modifying the templates.

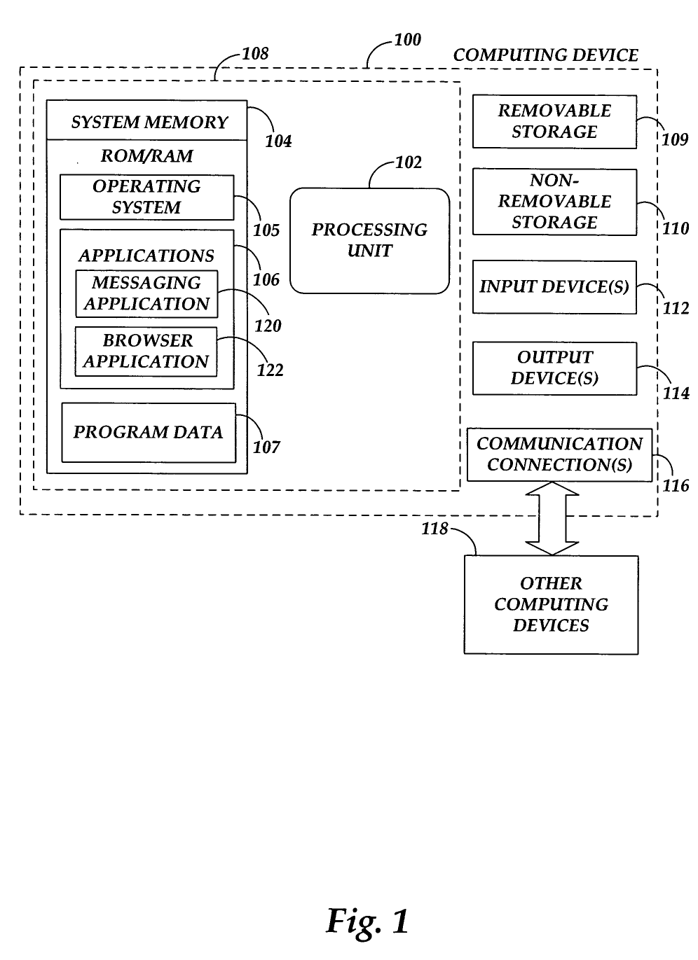

Referring now to the drawings, in which like numerals refer to like elements through the several figures, aspects of the present invention and an exemplary operating environment will be described. FIG. 1 and the following discussion are intended to provide a brief, general description of a suitable computing environment in which embodiments of the invention may be implemented. While embodiments of the invention may be described in the general context of program modules that execute in conjunction with an application program that runs on an operating system on a personal computer, embodiments of the invention may also be implemented in combination with other program modules.

An embodiment consistent with the invention may comprise a system for providing editable messaging forms. The system may comprise a system memory for maintaining a database and a processing unit coupled to the system memory. The processing unit may be operative to receive a template having at least one template field. Furthermore, the processing unit may be operative to map the at least one template field to at least one handler corresponding to the at least one template. In addition, the processing unit may be operative to execute the at least one handler to produce content associated with the at least one template field.

Consistent with an embodiment of the present invention, the aforementioned memory, processing unit, and other components may be implemented in a computing device, such as an exemplary computing device 100 of FIG. 1. Any suitable combination of hardware, software, and/or firmware may be used to implement the memory, processing unit, or other components. By way of example, the memory, processing unit, or other components may be implemented with any of computing device 100 or any of other computing devices 118, in combination with computing device 100. The aforementioned system, device, and processors are exemplary and other systems, devices, and processors may comprise the aforementioned memory, processing unit, or other components, consistent with embodiments of the present invention.

Generally, program modules may include routines, programs, components, data structures, and other types of structures that perform particular tasks or implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Embodiments of the invention, for example, may be implemented as a computer process (i.e. a method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, an exemplary system consistent with an embodiment of the invention may include a computing device, such as computing device 100. In a basic configuration, computing device 100 may include at least one processing unit 102 and a system memory 104. Depending on the configuration and type of computing device, system memory 104 may be volatile (such as RAM), non-volatile (such as ROM, flash memory, etc.) or some combination. System memory 104 may include an operating system 105, one or more applications 106, and may include a program data 107. In one embodiment, application 106 may include a messaging application 120 and a browser application 122, such as INTERNET EXPLORER®, manufactured by MICROSOFT CORPORATION. This basic configuration is illustrated in FIG. 1 by those components within a dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by a removable storage 109 and a non-removable storage 110. Computer storage media may include volatile and nonvolatile, removable and non-removable media implemented in any method or technology for storage of information, such as computer readable instructions, data structures, program modules, or other data. System memory 104, removable storage 109, and non-removable storage 110 are all examples of computer storage media. Computer storage media may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as a keyboard, a mouse, a pen, a voice input device, a touch input device, etc. Output device(s) 114 such as a display, speakers, a printer, etc. may also be included. The aforementioned devices are exemplary and others may be used.

Computing device 100 may also contain a communication connection 116 that may allow device 100 to communicate with other computing devices 118, such as over a network in a distributed computing environment, for example, an intranet or the Internet. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The term computer readable media as used herein may include both storage media and communication media.

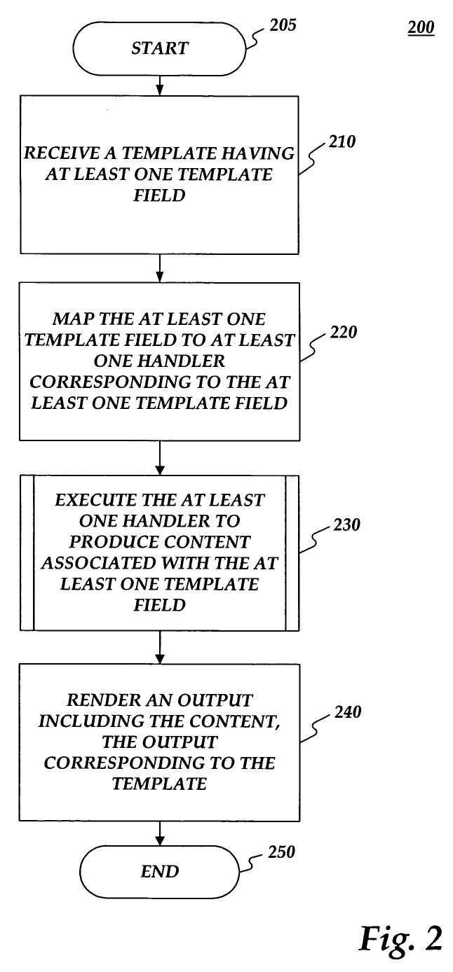

A number of program modules and data files may be stored in system memory 104 of computing device 100, including an operating system 105 suitable for controlling the operation of a networked personal computer, such as the WINDOWS operating systems from MICROSOFT CORPORATION of Redmond, Wash. System memory 104 may also store one or more program modules, such as messaging application 120, and others described below. While executing on processing unit 102, messaging application 120 may perform processes for providing editable messaging forms, including, for example, one or more of the stages of method 200 described below with respect to FIG. 2. The aforementioned process is exemplary, and processing unit 102 may perform other processes. Other applications 106 that may be used in accordance with embodiments of the present invention may include electronic mail and contacts applications, word processing applications, spreadsheet applications, database applications, slide presentation applications, drawing or computer-aided application programs, etc.

FIG. 2 is a flow chart setting forth the general stages involved in an exemplary method 200 consistent with the invention for providing editable messaging forms using system 100 of FIG. 1. Exemplary ways to implement the stages of exemplary method 200 will be described in greater detail below. Exemplary method 200 may begin at starting block 205 and proceed to stage 210 where computing device 100 may receive a template having at least one template field. For example, providing editable messaging form may begin with creating a window using browser application 122 followed by loading, for example, a template file into the created window. The template file may comprise, but is not limited to, a hyper-test markup language (HTML) file. The template file may include at least one tag that may correspond to the at least one template field that indicates where a given content should be placed in the created window. For example, in an e-mail context, the template field may correspond a “from” field, a “to” field, a “Cc” field, a “subject” field, a “body” field, or a “content” field. The aforementioned are exemplary, and the template field may correspond to other field types.

From stage 210, where computing device 100 receives the template having at least one template field, exemplary method 200 may advance to stage 220 where computing device 100 may map the at least one template field to at least one handler corresponding to the at least one template field. For example, by using browser application 122's element behaviors, each field in the template may map to a corresponding handler that may generate content for the field and may handle any actions associated with the field. The template may correspond to, for example, compose or read forms. The compose form, for example, may be what the user sees when the user creates a message using an application. The read form, for example, may be what is displayed to the user receiving and reading the form.

For read forms, for example, the handlers may provide read-only content. For compose forms, for example, additional handlers may provide editable fields by including, for example, an ActiveXObject containing a RichEdit control in the content. The handlers may maintain a connection to the RichEdit control for retrieving text when the composition is done. When saving or sending the composed message, a message class object may contain the logic required to create, for example, an IMessage object for future processing. The template file may function to provide layout for the form, including all e-mail fields and any actionable items, and to provide properties for initializing the handlers. By altering the collection of fields and the layout, new forms can be created through handler reuse. The same handler may be used in multiple instances of the field.

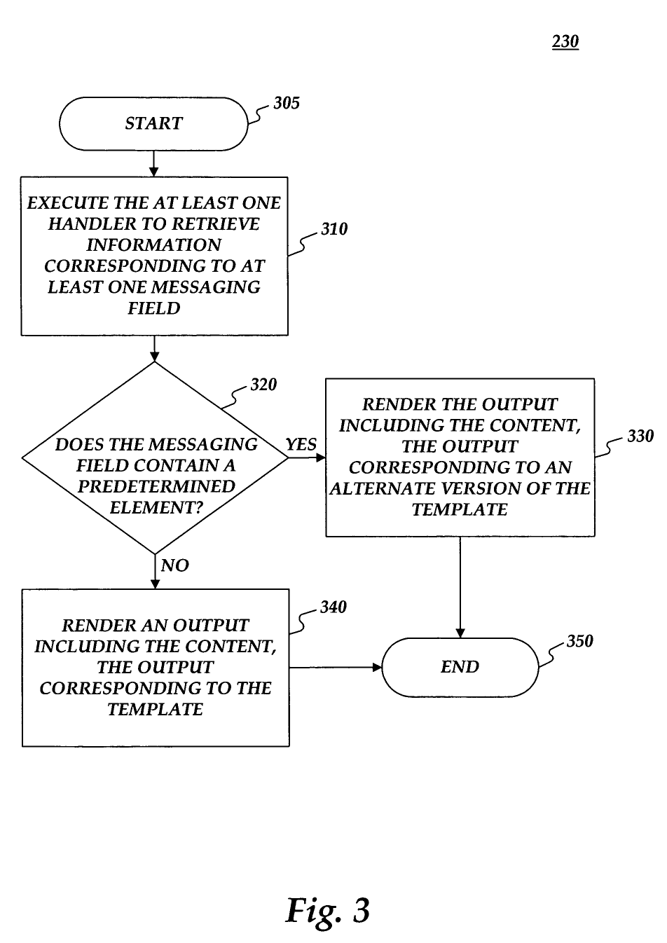

After computing device 100 maps the at least one template field to the at least one handler corresponding to the at least one template field in stage 220, exemplary method 200 may continue to exemplary subroutine 230 where computing device 100 may execute the at least one handler to produce content associated with the at least one template field. Exemplary ways to implement the stages of exemplary subroutine 230 will be described in greater detail below with respect to FIG. 3. For example, each handler may generate code (e.g. HTML code) for insertion into the created window by accessing a mail application interface (MAPI) and/or other sources to retrieve relevant data for the template field. The MAPI may comprise a programming interface that may enables a client application to send and to receive mail from a messaging system. Sample fields may include, but are not limited to, “to”, “Cc”, “from”, “subject”, and “body.” The handler may maintain a connection to the template using, for example, Internet Explorer element behaviors when browser application 122 comprises Internet Explorer. The aforementioned message class object's function may comprise encapsulating any logical differences between the different forms. Some examples of those differences may include locating the template to load, generating an IMessage object when composition is complete, and logic for handling smart replies and smart forwards for ActiveSync. This architecture also may enable the same window to render different message classes by replacing the message object and refreshing the template.

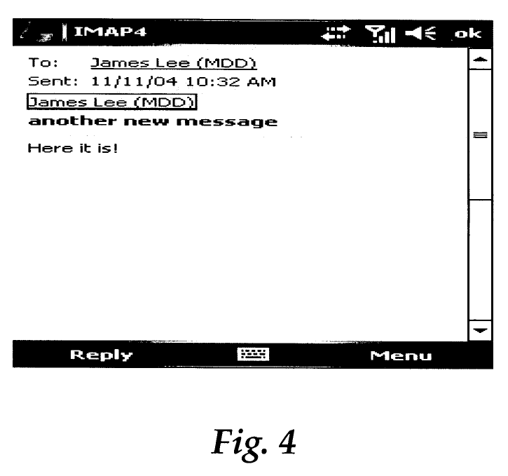

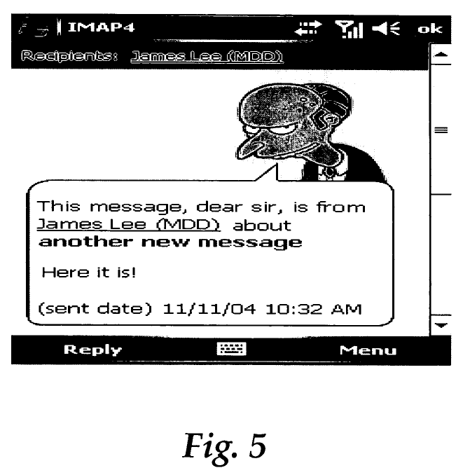

Once computing device 100 executes the at least one handler in exemplary subroutine 230, exemplary method 200 may advance to stage 240 where computing device 100 may render an output including the content, the output corresponding to the template. For example, computing device 100 may render an output comprising the message and content shown in FIG. 4 or FIG. 5. After computing device 100 renders the output including the content in stage 240, exemplary method 200 may then end at stage 250.

FIG. 3 describes exemplary subroutine 230 from FIG. 2 for executing the at least one handler. Exemplary subroutine 230 may begin at starting block 305 and proceed to stage 310 where computing device 100 may execute the at least one handler to retrieve information corresponding to at least one messaging field. For example, when executing the at least one handler, computing device 100 may access the aforementioned MAPI that may enable computing device 100 to access information associated with a message. When accessing the message information, computing device 100 may access the at least one messaging field comprising, for example, a “from” field, which may indicate from whom the corresponding message was sent.

Once computing device 100 executes the at least one handler to retrieve information corresponding to the at least one messaging field at stage 310, exemplary subroutine 230 may advance to decision block 320 where computing device 100 may determine if the messaging field contains a predetermined element. For example, computing device 100 may parse information from the aforementioned “from” field to determine if it contains, for example, a certain series of characters. Computing device 100 may parse information from the aforementioned “from” field to determine, for example, if it contains an alias corresponding to a certain person. For example, information from the “from” field may be parsed to see if it contains the character series “bjones@abc.com,” which may correspond to the alias of a certain person.

From decision block 320, if computing device 100 determines that the messaging field contains the predetermined element, exemplary subroutine 230 may proceed to stage 330 where computing device 100 may render an output including the content. The output may correspond to an alternate version of the template. For example, if the “from” field contains “bjones@abc.com,” the output may be rendered to look like the output shown in FIG. 5, which may comprise an alternate to the output shown in FIG. 4. The alias “bjones@abc.com” may correspond to a certain person with whom the user is familiar. Accordingly, the user may desire to have a message from that certain person to have a different look and feel from messages from other persons.

From decision block 320, if computing device 100 determines that the messaging field does not contain the predetermined element, exemplary method 230 may proceed to stage 340 where computing device 100 may render the output including the content, the output corresponding to the template. For example, if the “from” does not contain “bjones@abc.com,” the output may be rendered to look like the output shown in FIG. 4. After computing device 100 renders the output in stage 340, or from stage 330 where computing device 100 renders the output, exemplary method 230 may then end at stage 350.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specifically, the computer-readable medium examples (a non-exhaustive list) may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, aspects can also be stored on or read from other types of computer-readable media, such as secondary storage devices, like hard disks, floppy disks, or a CD-ROM, a carrier wave from the Internet, or other forms of RAM or ROM. Further, the disclosed method stages may be modified in any manner, including by reordering stages and/or inserting or deleting stages, without departing from the principles of the invention.

It is intended, therefore, that the specification and examples be considered as exemplary only, with a true scope and spirit of the invention being indicated by the following claims and their full scope of equivalents.

What is claimed is:

1. A method for providing editable messaging forms, the method comprising:
receiving a template having at least one template field;
mapping the at least one template field to at least one handler corresponding to the at least one template field; and
executing the at least one handler to produce content associated with the at least one template field.

2. The method of claim 1, further comprising rendering an output including the content, the output corresponding to the template.

3. The method of claim 1, wherein executing the at least one handler to produce the content further comprises executing the at least one handler to produce the content comprising read only content when the template corresponds to a read form.

4. The method of claim 1, wherein executing the at least one handler to produce the content further comprises executing the at least one handler to produce the content comprising editable content when the template corresponds to a compose form.

5. The method of claim 1, wherein executing the at least one handler to produce the content associated with the at least one template field further comprises executing the at least one handler to retrieve information from at least one messaging system.

6. The method of claim 5, wherein executing the at least one handler to retrieve the information from the at least one messaging system further comprises executing the at least one handler to retrieve the information corresponding to at least one of the following messaging fields: a field indicating a primary person to whom the message is directed to; a field indicating to whom the message is received from; a field indicating at least one secondary person to whom the message is directed to; a field indicating a message subject; and a field indicating a message body.

7. The method of claim 1, wherein executing the at least one handler to produce the content associated with the at least one template field further comprises:
executing the at least one handler to retrieve information corresponding to at least one messaging field;
determining if the messaging field contains a predetermined element;
rendering an output including the content, the output corresponding to the template if it was determined that the messaging field does not contain the predetermined element; and
rendering the output including the content, the output corresponding to an alternate version of the template if it was determined that the messaging field contains the predetermined element.

8. A system for providing editable messaging forms, the system comprising:
a memory storage for maintaining a database; and
a processing unit coupled to the memory storage, wherein the processing unit is operative to
receive a template having at least one template field;
map the at least one template field to at least one handler corresponding to the at least one template field; and
execute the at least one handler to produce content associated with the at least one template field.

9. The system of claim 8, further comprising the processing unit being operative to render an output including the content, the output corresponding to the template.

10. The system of claim 8, wherein the processing unit being operative to execute the at least one handler to produce the content further comprises the processing unit being operative to execute the at least one handler to produce the content comprising read only content when the template corresponds to a read form.

11. The system of claim 8, wherein the processing unit being operative to execute the at least one handler to produce the content further comprises the processing unit being operative to execute the at least one handler to produce the content comprising editable content when the template corresponds to a compose form.

12. The system of claim 8, wherein the processing unit being operative to execute the at least one handler to produce the content associated with the at least one template field further comprises the processing unit being operative to execute the at least one handler to retrieve information from at least one messaging system.

13. The system of claim 12, wherein the processing unit being operative to execute the at least one handler to retrieve the information from the at least one messaging system further comprises the processing unit being operative to execute the at least one handler to retrieve the information corresponding to at least one of the following messaging fields: a field indicating a primary person to whom the message is directed to; a field indicating to whom the message is received from; a field indicating at least one secondary person to whom the message is directed to; a field indicating a message subject; and a field indicating a message body.

14. The system of claim 8, wherein the processing unit being operative to execute the at least one handler to produce the content associated with the at least one template field further comprises the processing unit being operative to:
execute the at least one handler to retrieve information corresponding to at least one messaging field;
determine if the messaging field contains a predetermined element;
render an output including the content, the output corresponding to the template if it was determined that the messaging field does not contain the predetermined element; and
render the output including the content, the output corresponding to an alternate version of the template if it was determined that the messaging field contains the predetermined element.

15. A computer-readable medium which stores a set of instructions which when executed performs a method for providing editable messaging forms, the method executed by the set of instructions comprising:
receiving a template having at least one template field;
mapping the at least one template field to at least one handler corresponding to the at least one template field; and
executing the at least one handler to produce content associated with the at least one template field.

16. The computer-readable medium of claim 15, wherein executing the at least one handler to produce the content further comprises executing the at least one handler to produce the content comprising read only content when the template corresponds to a read form.

17. The computer-readable medium of claim 15, wherein executing the at least one handler to produce the content further comprises executing the at least one handler to produce the content comprising editable content when the template corresponds to a compose form.

18. The computer-readable medium of claim 15, wherein executing the at least one handler to produce the content associated with the at least one template field further comprises executing the at least one handler to retrieve information from at least one messaging system.

19. The computer-readable medium of claim 18, wherein executing the at least one handler to retrieve the information from the at least one messaging system further comprises executing the at least one handler to retrieve the information corresponding to at least one of the following messaging fields: a field indicating a primary person to whom the message is directed to; a field indicating to whom the message is received from; a field indicating at least one secondary person to whom the message is directed to; a field indicating a message subject; and a field indicating a message body.

20. The computer-readable medium of claim 15, wherein executing the at least one handler to produce the content associated with the at least one template field further comprises:
executing the at least one handler to retrieve information corresponding to at least one messaging field;
determining if the messaging field contains a predetermined element;
rendering an output including the content, the output corresponding to the template if it was determined that the messaging field does not contain the predetermined element; and
rendering the output including the content, the output corresponding to an alternate version of the template if it was determined that the messaging field contains the predetermined element.
